(19) United States
(12) Patent Application Publication
(10) Pub. No.: US 2012/0126988 A1
(43) Pub. Date: May 24, 2012

(54) Ionizing radiation detector

(76) Inventor: Arthur Lewis Kaplan, Beachwood, OH (US)

(21) Appl. No.: 12/803,434

(22) Filed: Nov. 23, 2010

(51) Int. Cl. G08B 17/12

(52) U.S. Cl. 340/600

(57) ABSTRACT

This invention is an ionizing radiation detector, disclosed to include a sensor of ionizing radiation, an electric current amplifier, a radiation level readout device, and a piezoelectric device.. This readout device could be, but not limited to, a meter, a sound-producing device, or light emitting diodes (LEDs). The ionizing radiation sensor produces an electric current in the sensor. This current is amplified by the amplifier. The amplified current is sent to the readout device, which indicates the level of the ionizing radiation dose rate. The piezoelectric device produces a sound when the ionizing radiation level exceeds a preset level. The existing prototypes utilize a photodiode as the sensor, an electric current amplifier, LEDs as the readout, and the piezoelectric device.

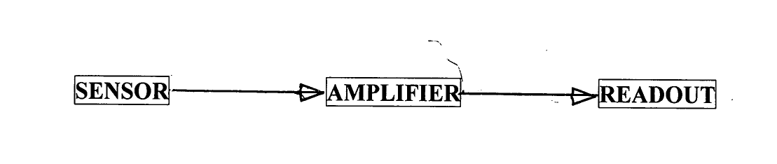

### BACKGROUND OF THE INVENTION:

1. Field of the invention

The present invention relates to a new ionizing radiation detector, and more particularly to an inexpensive sensor, an amplifier that provides a greater gain (range of amplification) than existing ones used in conventional radiation detectors, a readout device that is far easier to interpret than those currently in use, and a piezoelectric device that emits a sound when the radiation dose rate exceeds a preset level.

2. Description of the Related Art

Conventional ionizing radiation detectors used for measuring radiation exposure dose and/or dose rate commonly use a sensor, an amplifier, and a readout device. The readout is usually a display that indicates the exposure dose or dose rate. This exposure dose or dose rate display may either be an analog meter or a digital readout device. Anyone using a conventional detector must understand the meaning of any particular exposure dose or dose rate reading, related to her/his risk of adverse health effects from exposure to that dose or continued exposure to that dose rate level. She/He must be trained to understand these risks, especially when she/he is responsible for the safety of others, if they are at potential risk from such radiation exposure dose. Also, conventional detectors generally measure doses or dose rates only over a few decades (factors of ten) of dose rate levels, e.g. 1-10 units, 10-100 units; 100-1,000 units, 1,000-10,000 units.

Also, these conventional detectors are relatively expensive to manufacture.

Therefore, it is desirable to provide a new ionizing radiation detector that addresses the aforementioned problems.

### SUMMARY OF THE INVENTION

This invention accomplishes the following:

It amplifies the very low current, e.g. less than one-tenth picoampere, generated in the sensor from a gamma ray dose rate of about one rem per hour, in this case a photodiode, to levels above one milliampere. This allows the use of readout devices different from meters or digital readout devices, such as light emitting diodes (LEDs) used in this invention.

It replaces the conventional readout devices with a series of LEDs, each of which emits a different color. These LEDs indicate a range of dose rate levels, such as 0.05-0.5 millirem per hour, 0.5-5 millirem per hour, 5-10 millirem per hour, 10-50 millirem per hour, 50-100 millirem per hour, 100-500 millirem per hour, 500-1 rem per hour (1,000 millirem per hour), 1-5 rem per hour, 5-10 rem per hour, 10-50 rem per hour, 50-100 rem per hour, and greater that 100 rem per hour, for a total of seven decades of dose rate range. Similarly, the dose-measuring feature of this invention would measure dose level ranges over seven decades (factors of ten).

It emits a sound when the dose rate level exceeds about 10 millirem per hour

It can be manufactured at a cost of less than one third of the cost to manufacture the least 4 expensive conventional device.

It can be used in many applications, in which conventional devices cannot be used, including but nit limited to (as described above in the Claims section of this application):

Individuals inside or outside of various structures.

First responders, entering an area inside or outside of a structure, where the presence of ionizing radiation may be known or unknown.

Military personnel in combat or non-combat situations in which a nuclear weapon or a “dirty bomb” may be detonated.

Individuals who are exposed occupationally to ionizing radiation, who need to be alerted when their individual radiation exposure reaches a level equivalent to a maximum permissible exposure, as designated by a government regulatory agency or by any other authority governing the conditions of the occupational exposure.

### BRIEF DESCRIPTION OF THE DRAWING

The drawing is a sketch, which shows the main components of the invention. These main components are an ionizing radiation sensor, and amplifier, and a readout device.

### DETAILED DESCRIPTION OF THE PREFERRED EMBODIMENT

The present invention is comprised of an ionizing radiation sensor, an electric current amplifier, a readout device, and a piezoelectric device.

The sensor generates an electric current when exposed to ionizing radiation. The amplifier amplifies this current to a level that can activate a readout device. The readout device indicates the dose rate level of ionizing radiation to which the sensor is exposed.

The sensor is a photodiode, chosen to maximize the current it generates when exposed to ionizing radiation.

The current amplifier has been designed to provide a gain (amplification factor) of over seven decades, to provide an output current large enough to activate a readout device.

The readout device is a series of light emitting diodes (LEDs), each of which emit a light of a different color, when activated by an electric current. This prototype uses LEDs each of which emits red, orange, yellow, green, blue, and white light.

The piezoelectric device indicates that the sensor is being exposed to a dose rate equal to or greater than 10 millirem per hour

There are eight LEDs used in this invention. The dose rate ranges indicated by these LEDS, and the colors emitted by each LED in our prototype, are:

0.05-0.5 millirem per hour: Green

0.5-5 millirem per hour: Blue

5-10 millirem per hour: Blue-Yellow*

10-50 millirem per hour: Yellow

50-100 millirem per hour: Yellow-Orange*

100-500 millirem per hour: Orange

500-1 millirem per hour (1000 millirem per hour): Orange-Red*

1-5 rem per hour White

5-10 per hour: White-White*

10-50 rem per hour rem per hour White

50-100 rem per hour White-White*

Greater than 100 rem per hour White

*Indicates two adjacent LEDs lighting at the same time.

Any colors emitted by LEDs, and in any combination, may be used for this application.

Conventional ionizing radiation detectors used for measuring radiation exposure dose and/ or dose rate commonly use a sensor, an amplifier, and a readout device. The readout is usually a display that indicates the exposure dose or dose rate. This exposure dose or dose rate display may either be an analog meter or a digital readout device. Anyone using a conventional detector must understand the meaning of any particular exposure dose or dose rate reading, related to her/his risk of adverse health effects from exposure to that dose or continued exposure to that dose rate level. She/He must be trained to understand these risks, especially when she/he is responsible for the safety of others, if they are at potential risk from such radiation exposure dose. Also, conventional detectors generally measure doses or dose rates only over several decades of dose rate levels, e.g. 1-10 units, 10-100 units; 100-1,000 units, 1,000-10,000 units.

Therefore, it is desirable to provide a new ionizing radiation detector that addresses the aforementioned problems.

A prototype of the new ionizing radiation detector has been constructed with the features as described herein. This prototype measures dose rate, but it can be easily modified with a current integrator to also measure dose. The cost to manufacture this invention would be at least one-third of that for the least expensive conventional detector.

Although particular embodiments of the invention have been described in detail for purposes of illustration, various modifications and enhancements may be made without departing from the spirit and scope of the invention.

1. The GRD Series Radiation Detector (hereinafter called “Detector”) is designed to respond to ionizing radiation, including but not limited to alpha, beta and/or gamma radiation (hereinafter called “ionizing radiation”). It can also be designed to measure secondary radiation including, but not limited to, visible light (at wavelengths between 100 and 800 nanometers) generated in any material from ionizing radiation. This detector also emits a sound when the ionizing radiation level exceeds a preset limit.

2. The sources of ionizing radiation from which the detector measures the ionizing radiation shall include, but not limited to:
Single accumulation of any material emitting ionizing radiation (hereinafter called “sources of radioactive material”);
Single sources of radioactive material in a single location;
Single sources of radioactive material in multiple locations;
Multiple sources of radioactive material in a single location;
Multiple sources of radioactive material in multiple locations;
The single detonation or multiple detonations of a nuclear weapon at a single location;
The single detonation or multiple detonations of a nuclear weapon at multiple locations;
The single detonation of, or multiple detonations of, a bomb containing radioactive material (sometimes known as a “dirty bomb”) at a single location;
The single detonation of, or multiple detonations of, a bomb containing radioactive material (sometimes known as a “dirty bomb”) at a single location;
The single detonation of, or multiple detonations of, a bomb containing radioactive material (sometimes known as a “dirty bomb”) at multiple locations;
A single nuclear reactor, or from multiple nuclear reactors at a single location;
A single nuclear reactor, or from multiple nuclear reactors at multiple locations;
Any other single source or multiple source of radioactive materials at a single location;
Any single generator of ionizing radiation, including but not limited to x-ray machines, or multiple generators of ionizing radiation, including but not limited to x-ray machines, at a single location;
Any single generator of ionizing radiation, including but not limited to x-ray machines, or multiple generators of ionizing radiation, including but not limited to x-ray machines, at multiple locations.

3. The Detector consists of the following:
A sensor, including but not limited to, a solid state device that generates an electrical current when exposed to ionizing radiation, or to secondary radiation produced by radiation-emitting materials when exposed to ionizing radiation;
An amplifier;
Indicators of the presence of any ionizing radiation (hereinafter called “readout devices”, including but not limited to, one or more Light Emitting Diodes (hereinafter called “LEDs”); and
A piezoelectric device to generate a sound when the ionizing radiation level exceeds a specific level.
Some kind of a container such as, but not limited to, a plastic box.

4. The container for the detector components may be any sizes, any shapes, or any materials, which do not prevent the detector from measuring ionizing radiation or secondary radiation produced by radiation-emitting materials, when they are exposed to ionizing radiation.

5. Additional alerting devices, including but not limited to a sound response may also be included in the Detector.

6. This detector can be used by, but not limited to, the following:
Individuals inside or outside of various structures.
First responders, entering an area inside or outside of a structure, where the presence of ionizing radiation may be known or unknown.
Military personnel in combat or non-combat situations in which a nuclear weapon or a “dirty bomb” may be detonated.
Individuals who are exposed occupationally to ionizing radiation, who need to be alerted when their individual radiation exposure reaches a level equivalent to a maximum permissible exposure, as designated by a government regulatory agency or by any other authority governing the conditions of the occupational exposure.

7. This detector can be used to measure a single exposure rate (hereinafter called “dose rate”) or multiple exposure rates (hereinafter called “dose rates”) of any ionizing radiation at
A single location.
Multiple locations.

8. This detector can be used for the following various, but not limited to the following, purposes: measure a single exposure (hereinafter called “dose”) or multiple exposures (hereinafter called “doses”) of any ionizing radiation at:
A single location.
Multiple locations.

9. This detector can be used for the following various, but not limited to the following, purposes: measure a single exposure (hereinafter called “dose”) or exposure rate (hereinafter called “dose rate”), or multiple exposures (hereinafter called “doses”) or exposure rates (hereinafter called “dose rates”), of any ionizing radiation using, but not limited to,
Single sensor or multiple sensors at a single location.
Single detector or multiple detectors at multiple locations.

10. This detector can be used as follows:
Stationary or portable sensor or sensors, as described above in all previous claims.
Stationary or portable detector or detectors, as described above in all previous claims.
